(19) United States
(12) Patent Application Publication
(10) Pub. No.: US 2025/0225574 A1
(43) Pub. Date: Jul. 10, 2025

(54) Closing Auction

(71) Applicant: Cboe Exchange, Inc., Chicago, IL (US)

(72) Inventors: Bryan Blake, Toronto (CA); Vincent Poil, Toronto (CA)

(21) Appl. No.: 19/011,218

(22) Filed: Jan. 6, 2025

Related U.S. Application Data
(60) Provisional application No. 63/618,137, filed on Jan. 5, 2024.

(51) Int. Cl. G06Q 30/08

(52) U.S. Cl. CPC G06Q 30/08

(57) ABSTRACT

Disclosed herein is a system having one or more non-transitory computer storage media having instructions that, when executed, cause one or more computers to receiving at least one message. Each message including a requested order to be executed during a blind auction. A filter can be applied during a plurality of auction periods to permit one or more requested orders that have an order type satisfying an order type criterion defined for a current auction period. The permitted one or more requested orders are to be processed during a closing period of the blind auction. In response to determining that an imbalance period has started, one or more imbalance messages can be generated using a reference model. During a closing period, the blind auction can be closed based on the permitted one or more orders and using a matching criterion.

### CROSS-REFERENCE TO RELATED APPLICATION

This application claims the benefit of U.S. Provisional Patent Application No. 63/618,137, filed Jan. 5, 2024, which is incorporated herein by reference in its entirety.

### BACKGROUND

High volumes of financial instruments such as derivatives, stocks, and bonds are continuously traded at electronic exchanges, which enable trades to occur in real time through the algorithmic processing of orders and associated market information. Financial instruments can also be traded through auctions.

### SUMMARY

This disclosure describes improved auction systems and methods implemented in an exchange computer system that provides numerous benefits including greater centralized liquidity, reduced imbalance and price volatility, increased size executions, and several other technical benefits described below, for securities at or around the opening and closing of markets.

In some implementations, the improved auction systems and methods include a blind auction and a fixed closing time, thereby enabling fair, predictable, and efficient market participation. The blind auction can be executed alongside continuous trading. Imbalance messages to inform participants of the existing in a market can be issued periodically during certain phases of the blind auction. Moreover, new rules and procedures can be implemented to limit the types of orders that can be received at different phases of the auction and the types of orders that can be canceled or modified at the different phases.

In some implementations, an extended trading session can be implemented after closing that allows matching and trading to be completed after the closing of an auction, but only at the closing price of the auction.

The implementations described herein provide various technical and business benefits. For instance, through the periodic transmission of customized imbalance messages using a reference price model, market information can be published to participants ensuring equal and fair distribution of market intelligence, reduced price volatility, and to facilitate continuous involvement with the auction.

Opening and closing call times at exchanges can be hectic depending on market conditions. However, by implementing a multi-staged blind auction and with limits as to when imbalance messages are published and certain types of orders can be accepted, modified, or canceled, the improved auction system provides more predictability to the auction, which also allows the exchange system to better allocate its system resources. For instance, by implementing a fixed closing period instead of a randomized closing period, the exchange system can anticipate and allocate greater resources to the closing cutoff time prior to the closing period and ensure that sufficient resources are available if a high volume of messages and orders is received at the closing cutoff time. With such improved load balancing, the exchange system can operate faster with less chances of system overload or errors.

In some aspects of the disclosure, an exchange computer system is described. The exchange computer system has at least one communication interface that is configured to receive from one or more computing devices coupled to a routing system of the exchange computer system and via a computer network, at least one message and execute an action during one or more sessions. In some instances, the execution of the action can be performed at one of multiple operation modes that are associated with respective configuration for execution of the auction and defines relevant rules (e.g., order type rules, time schedule, data distribution rules, etc.) relevant for permitting orders to be executed during a closing period of the auction.

The exchange computer system includes at least one non-transitory computer-readable storage medium configured to store data related to received messages and/or requested orders for trade execution through at least one of the messages. In some instances, the received messages are associated with orders of various types that are requested for execution through an auction provided through an auction engine of the exchange computer system. The auction engine can include at least one hardware processor coupled with the at least one non-transitory computer-readable storage medium. The at least one non-transitory computer-readable storage medium is further configured to store computer-executable instructions that when executed by the at least one hardware processor, cause the auction engine to perform action processes. The processes include executing an action in an operational mode selected from a set of available operational modes.

In some instances, the auction engine is configured to execute a blind auction during a first session. During the execution of the blind auction in the first session, an order type is identified in each order requested through the at least one message received from a routing system of the exchange computer system and/or directly from communicatively coupled computing devices used to request orders. The identification of an order type is configured to be performed by extrapolating one or more bits from each of the at least one message corresponding to an order type field in each of the at least one message. The one or more bits as extrapolated from each message can be compared to data in a reference table (e.g., a look-up table stored in one or more databases coupled to the exchange computer system). An order type can be identified for each requested order through the at least one message based on the comparison. It can be determined that one or more of the identified order types satisfies a determined order type criterion, and a filter can be applied to permit one or more orders that have the one or more of the determined order types satisfying the determined order type criterion to be processed during a closing period defined for the blind auction. One or more imbalance messages can be generated using a reference model. The one or more imbalance messages can include imbalance information associated with the blind auction. The imbalance messages can be distributed according to a defined time schema for sharing imbalance information during a blind action (e.g., the time schema for the blind action may differ from a time schema relevant for another operation mode of an auction configured through the exchange computer system). During the closing period, the blind auction can be closed based on the permitted one or more orders and using a matching criterion. The one or more orders that are permitted can be executed through the auction engine, through an order matching system of the exchange computer system that is coupled to the auction engine, or through another execution engine external to the exchange computer system, among other examples. A notification message can be transmitted through the routing system to the computer network indicating an outcome of the blind auction.

The implementation of a blind auction can be defined according to a predefined process that utilizes functionalities exposed by a computer system that provides a platform environment that permits orders of different types during periods of the auction so that the permitted orders can be executed at close of the auction. In some implementations, a processor of the computer system can be configured to receive messages associated with requested orders and execute a blind auction alongside continuous trading sessions on a trading day. In some instances, the blind auction can be executed for securities issued by predefined issuers. In some implementations, the computer system can be an auction engine or another processor part of an exchange computer system where messages from computer devices of market participants can be received through a routing system.

In some implementations, the processor of the computer system can be configured to operate in multiple operation modes. The multiple modes can include a first operation mode in which the processor is configured to execute a transparent auction and generate a first set of imbalance messages throughout the transparent auction. In some cases, the multiple modes can include a second operation mode in which the processor is configured to execute the blind auction and the one or more imbalance messages are generated during an imbalance period and the closing period of the blind auction.

In some implementations, the processor is configured to generate the one or more imbalance messages using the reference model, where each imbalance message is generated to include a plurality of fields including: a symbol field indicative of a symbol associated with a security; a reference price field associated with a price level at or within a national best bid and offer; a reference buy shares field associated with a total number of shares for a buy side of an order priced at a value equal to or greater than a reference price associated with the reference model; a reference sell shares field associated with a total number of shares for a sell side of an order priced at a value equal to or less than the reference price; an indicative price field associated with a first type of closing price; and an auction only price field associated with a second type of closing price. In some implementations, the first type of closing price is a price that maximizes a number of shares matched based on on-close orders and visible continuous orders; and the second type of closing price is a price that maximizes a number of shares matched based only on on-close orders.

In some implementations, the blind auction is configured to be executed in multiple phases defining periods when orders are processed and determined whether to be permitted for execution during the closing period. In some implementations, the blind auction includes at least a first period, a second period, a third period, a fourth period, and a fifth period. During the first period, the applied filter can be configured to filter orders by permitting orders of order types corresponding to a market on close order and a limit on close order. During the first period, the filter can be configured to allow modification or cancelation of orders of those types (modify or cancel the market on close order or the limit on close order that were previously made). During the second period, the filter can be configured to filter orders by rejecting a cancellation of a previously-recited market on close order or a previously-received limit on close order, and to permit a modification of a previously-recited limit on close order that modifies a pricing in the limit on close order to a price associated with a higher aggression level. During the second period, the processor can be configured to generate and transmit the one or more imbalance messages periodically. During the third period, the filter can be configured to filter orders by rejecting a cancellation or a modification of a previously-recited market on close order, a previously-received limit on close order, and a previously-received late limit on close order, and to permit newly-received late limit on close order that has a price level that does not exceed a national best bid and offer level. During the third period, the processor can be configured to generate and transmit the one or more imbalance messages periodically. During the fourth period that is the closing period, the processor can be configured to receive orders that were permitted by the filter (during the various periods), to conduct and close the blind auction based on the orders that were permitted by the filter. During the fifth period, the processor can be configured to implement a price movement extension for orders that were not permitted by the filter.

In some implementations, the processor is configured to determine a closing auction price during the closing period by determining a price that maximizes a volume of financial instruments to be traded.

In some implementations, the computer system includes a timing circuit configured to provide a signal to the at least one processor indicating a time of day. The one or more databases can be configured to store the look-up table, a set of order type criteria including the determined order type criterion, and a set of matching criteria including the matching criterion. The set of order type criteria and the matching criteria can be respectively defined for each period of auction periods of the blind auction. In some instances, the processor can be configured to apply the filter, at each period of the auction periods of the blind auction, so as to permit the one or more orders based on a time stamp associated with each requested order, a respective order type criterion for each period, and the time of day indicated by the signal received from the timing circuit.

In some implementations, the blind auction can be executed during a first session. The first session can be a continuous trading session that is implemented in parallel with the blind auction.

Certain implementations may provide various advantages. For example, the disclosed technology can be used to enhance the speed and efficiency with which an exchange computer system processes high volumes of orders during a closing auction. The disclosed technology implements a blind auction that can be executed at an auction engine so that greater centralized liquidity, reduced price volatility, and increased amounts of executions for securities at periods of time during the trading day (e.g., the opening and closing of markets) can be supported. The configuration of the execution of a blind auction as an operation mode for executing auctions at an auction engine of an exchange computer system can support improved performance for the transaction execution without increase of the hardware requirements. The effectively leveraging of the availability of the price information during the various periods of the blind auction can reduce the computational resource requirements to scale with fluctuating size of order requests due to published order information during the trading day. With the implementations of a blind auction, requests for orders can be more evenly distributed over the auction period without creating spikes at peak end periods proximate to the closing period. In some instances, the auction engine environment can provide functionality to suppress a trade from the tape by cancelling the newest/oldest order and/or decrement and cancel an order. Such functionality can prevent inadvertent crosses where a resulting trade may provide no change of beneficial interest of a market participant. Exposing such functionality can improve the quality of services, price discovery and usability of the auction functionality.

The details of one or more embodiments of the subject matter described in this specification are set forth in the accompanying drawings and the description below. Other potential aspects, features, and advantages will be apparent from the description, the drawings, and the claims.

### BRIEF DESCRIPTION OF THE DRAWINGS

FIG. 1 is a diagram of an example of an environment having an exchange computer system and associated networks, devices, and users.

FIG. 2 is a diagram of an example exchange computer system configured to enable auction execution.

FIG. 3A is s an illustration of periods of a blind auction where different rules for messaging and permission rules for order types are defined so that the action can be executed through the auction engine of FIGS. 1-2.

FIG. 3B is an illustration of executing an auction in multiple modes including a schema for executing a fully transparent auction and a blind auction, where the auctions can be through the auction engine of FIGS. 1-2.

FIG. 4A is a flowchart of an example process for implementing a blind auction on the exchange computer system of FIGS. 1-2.

FIG. 4B is a flowchart of an example process for implementing a multimodal auction process on the exchange computer system of FIGS. 1-2.

### DETAILED DESCRIPTION

This disclosure relates to a computer system configured to receive messages and execute an auction, such as a blind auction, during which imbalance messages are provided when imbalance period of the blind auction starts. The implementations described herein also reduce the consumption of network resources and bandwidth utilization particularly on days when market volatility is high, thereby allowing exchange systems to operate more smoothly when processing orders during a blind auction.

According to the implementations described herein, messages with orders can be received at an order routing server and provided for processing at an auction engine configured to execute an auction. The auction engine can be configured to work in one or multiple operation modes. In some implementations, the auction engine can be configured to execute a blind auction. The blind auction can be defined as a process including multiple periods or phases during which orders can be received and processed according to defined rules and schemas for determining whether to permit orders to be executed at close. When an imbalance period of the blind auction is determined to have started, imbalance messages can be generated to include information associated with the blind auction and transmitted to be provided to computing devices of market participants associated with the requested orders.

In some instances, the blind auction can be configured to include a participation phase in the auction, a closing calculation price phase where orders are matched, and an extended trading phase. For example, the blind auction can be implemented at an exchange computer system in a manner allowing it to dynamically, efficiently, and continuously to process received orders and generate imbalance messages when imbalance phase starts based on information received by the exchange both locally and through a computer network, and to efficiently transmit that imbalance messages (e.g., according to a timing schedule) to connected computing devices in real-time.

In some implementations, the exchange computer system can provide functionality for executing an action in a blind auction operation mode alongside continuous trading. During the blind auction, requested orders by market participants in the blind auction are not published during imbalance phase of the blind auction but rather, imbalance messages are generated and provided for publishing during imbalance phase (e.g., according to a predefined time schedule, such as every 5, 10, or 15 second, among other examples). During the blind auction, respective rules and criteria can be defined into a filter that is applied to permit orders to be included into the auction. When the imbalance period starts, imbalance messages are provided to auction participants, new orders (such as market on close orders and limit on close orders) may be entered for as long as they satisfy respective order type criteria. For example, previously entered orders may not be cancelled or amended unless they satisfy an order type criterion for permitting orders during the imbalance period.

The imbalance messages can be generated using a reference price model so that the imbalance messages are indicative of imbalance information associated with the execution of the blind auction. In some instances, the imbalance messages can be considered as indicators including information that is disseminated at defined time points. The imbalance messages provide a reference to instruments that are paired at a given price. The imbalance messages can include multiple fields such as one or more of the following:
a symbol field indicative of a symbol associated with a security—for example, this can be a ticker of a listed security to provide indication on the imbalance message;
a reference price field associated with a price level at or within a national best bid and offer—the reference price field can define a price level that maximizes the matched volume of market on close (“MOC”) and limit of close (“LOC”) orders;
a reference buy shares field associated with a total number of shares for a buy side of an order priced at a value equal to or greater than a reference price associated with the reference model;
a reference sell shares field associated with a total number of shares for a sell side of an order priced at a value equal to or less than the reference price;
an indicative price field associated with a first type of closing price—the indicative price field includes a calculated closing price that maximizes the number of shares matched based on on-close orders (MOC or LOC) and visible continuous market orders; this indicative price can be considered as the final closing price if the auction is to end at that moment; and.
an auction only price field associated with a second type of closing price—the second type of closing price is indicative of a calculated closing price that excludes continuous market orders and is to maximize the number of shares matched based on closing interest only (MOC or LOC).

At the end of a trading session, orders that are permitted into the auction (e.g., eligible for participation in the closing call) can be included in the closing call, while those that are filtered out can be considered during an extended trading session that is subsequent to the closing period.

During the closing period, closing price is calculated by combining orders permitted to be processed during the closing period. The closing price is determined as a single price based on which the trade volume during the closing period can be maximized. In some cases, more than one closing price can be identified to provide equal volume trade, and in those cases, predefined rules can be obtained and applied to select a single price from the multiple price options. Orders that are permitted into the closing period can be matched at the closing price according to a predefined sequence. The predefined sequence can be a sequence defined with respect to order type and/or price defined in the order.

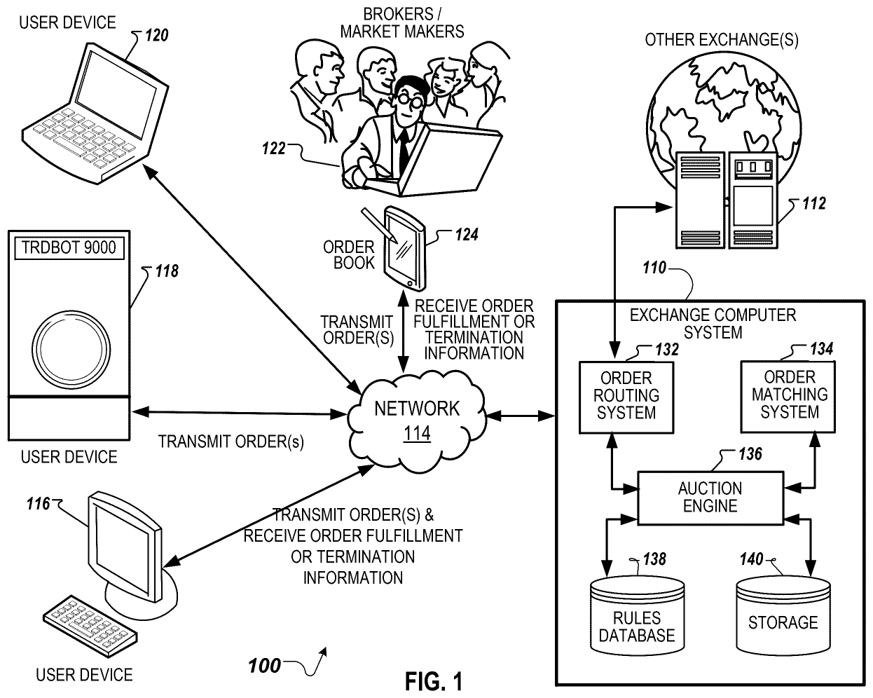

FIG. 1 is an example diagram of an environment 100 having an exchange computer system 110 configured to enable executing a closing auction in multiple operation modes, and the associated networks, devices, and users that make up an exemplary trading environment in which that system operates. Generally, the term “user” may refer to any entity that interacts with the exchange computer system and/or associated networks and devices. Users may include, for example, market makers and other market professionals, brokers, institutional traders, individual traders, and automated trading systems. The diagram includes an exchange computer system 110, other exchanges 112, a network 114, user devices 116, 118, 120, market makers/brokers 122, and an electronic order book 124. The exemplary methodologies claimed below may, for example, run on exchange computer system 110.

The exchange computer system 110 may be implemented in a fully electronic manner, or in a hybrid manner that combines electronic trading with aspects of traditional open-outcry systems. The exchange computer system 110 may receive orders for trading financial instruments locally on the floor and from remote electronic devices. The financial instruments may include securities such as stocks, options, futures contracts, or other derivatives associated with an underlying asset.

Network 114 connects the various components within the trading environment, and may be configured to facilitate communications between those components. The network 114 may, for example, be configured to enable the exchange of electronic communications that include order and order fulfillment information between connected devices, such as an electronic order book 124 and the exchange computer system 110.

The network 114 may include one or more networks or subnetworks, each of which may include a wired or wireless data pathway. Network 114 may, for example, include one or more of the Internet, Wide Area Networks (WANs), Local Area Networks (LANs), or other packet-switched or circuit-switched data networks that are capable of carrying electronic communications (e.g., data or voice communications). To protect communications between the various systems, devices, and components connected to network 114, the network 114 can implement security protocols and measures such that data identifying order or bid information, or parties placing orders or quotes, can be securely transmitted. Network 114 may, for example, include virtual private networks (VPNs) or other networks that enable secure connections to be established with exchange computer system 110.

User devices 116, 118, and 120 may include portable or stationary electronic devices, such as smartphones, laptops, desktops, and servers that include user interfaces to display information and receive user input, and that are configured to communicate over a computer network, such as the network 114. User devices 116, 118, and 120 may communicate with the exchange computer system 110 over network 114 using a proprietary protocol, or a message-based protocol such as financial information exchange (FIX), implemented over TCP/IP. User devices 116, 118, and 120 may transmit user input such as order information or risk information to the exchange computer system 110, and may also receive data from the exchange computer system 110 indicating that an order has been filled or canceled. Users such as brokers/market makers 122 may also place orders and receive information about order fulfillment or termination through electronic order book 124, which may include a record of outstanding public customer limit orders that can be matched against future incoming orders.

The exchange computer system 110 includes an order routing system (ORS) 132, an order matching system (OMS) 134, an auction engine 136, a database of auction rules and algorithms in a rules database 138, and storage 140. In some implementations, the exchange computer system 110 is a distributed computer system. The order routing system (ORS) 132 determines whether a received order or quote is to be executed at the exchange computer system 110, or should instead be redirected to another exchange 112 external to the exchange computer system 110. The ORS 132 can include processing systems that enable the management of high data volumes. For example, the ORS 132 can receive order or quote information for the purchase or sale of financial instruments from one or more user devices 116, 118, 120, and 124. In some implementations, the ORS 132 can also be connected to or include a touch-screen order routing and execution system accessible by brokers on the exchange floor, such as a public automated routing (PAR) system.

Upon receiving an order or quote, the ORS 132 determines whether the destination specified in the received order or quote is the exchange computer system 110. If the exchange computer system 110 is not the destination, the ORS 132 forwards the order or quote to another exchange 112, which can be either the destination exchange, or an exchange en route to the destination exchange. If the ORS 132 determines that the exchange computer system 110 is the destination of the received order or quote, the ORS 132 can forward the received order or quote to the OMS 134.

The order matching system (OMS) 134 can include processing systems that analyze and manipulate orders according to matching rules stored in the database 138. In some implementations, the OMS 134 includes an electronic book (EBOOK) of orders and quotes with which incoming orders to buy or sell are matched, according to the matching rules. The EBOOK can also be implemented in a separate database such as storage 140, which can include multiple mass storage memory devices for the storage of order and quote information. When the OMS 134 determines that a match exists for an order (for example, when a bid matches an offer for sale), the OMS 134 can mark the matched order or quote with a broker-specific identifier so that the broker sending the order or quote information can be identified.

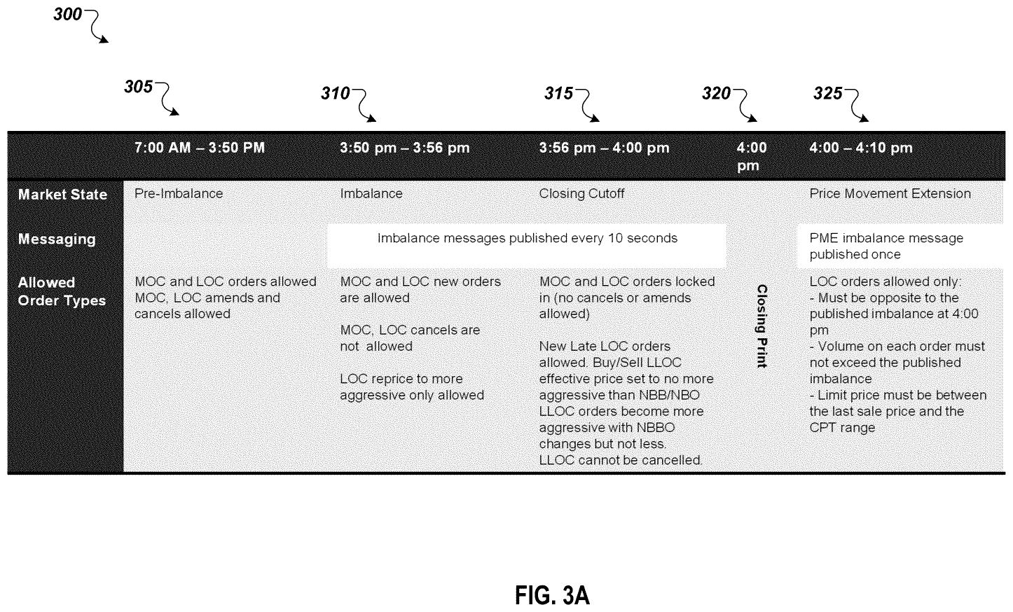

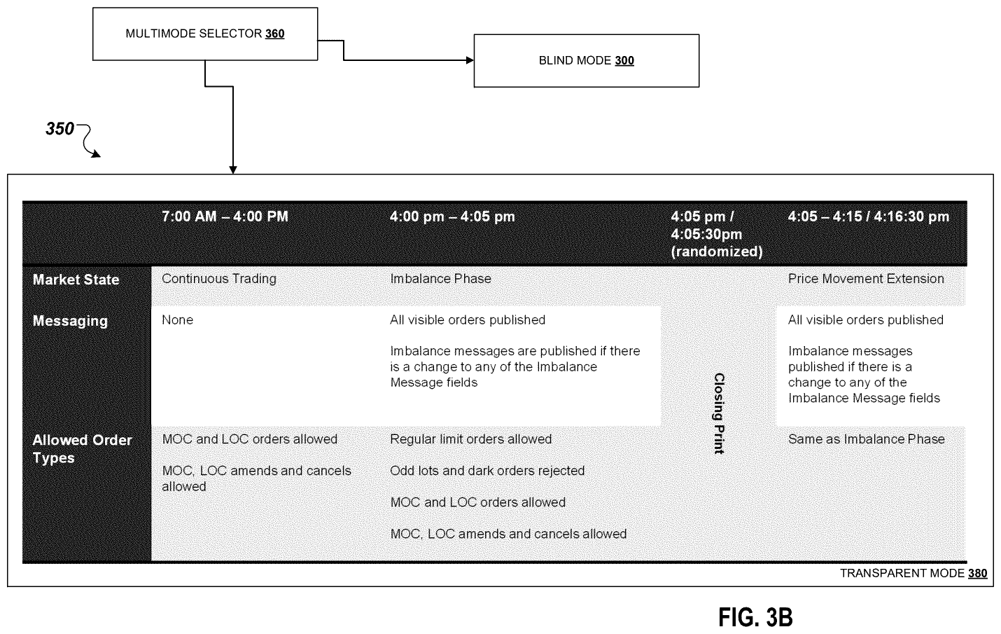

In some implementations, the OMS 134 determines whether the order is an order for an auction. The OMS 134 may pre-screen orders to determine whether orders comply with the requirements of participating in a particular mode of an auction, such as a blind auction. In particular, the OMS 134 determines whether the date and time parameter of a received order complies with the requirements of an auction at various periods defined for the auction, as described in more detail in relation to the methods 400 and 450 below, and the rules and time schema for different operation modes of auctions as described in relation to FIGS. 3A and 3B. Advantageously, when the OMS performs a portion of the closing operations of the method 400 where permitted orders are processed using a matching criteria, the auction engine 136 can dedicate more resources on filtering orders and generating imbalance messages, thus effectively leveraging presentation of imbalance information to market participants based on the available data from requested orders to increase profitability of the exchange computer system 110, 200 by executing trades without increasing computational and hardware requirements.

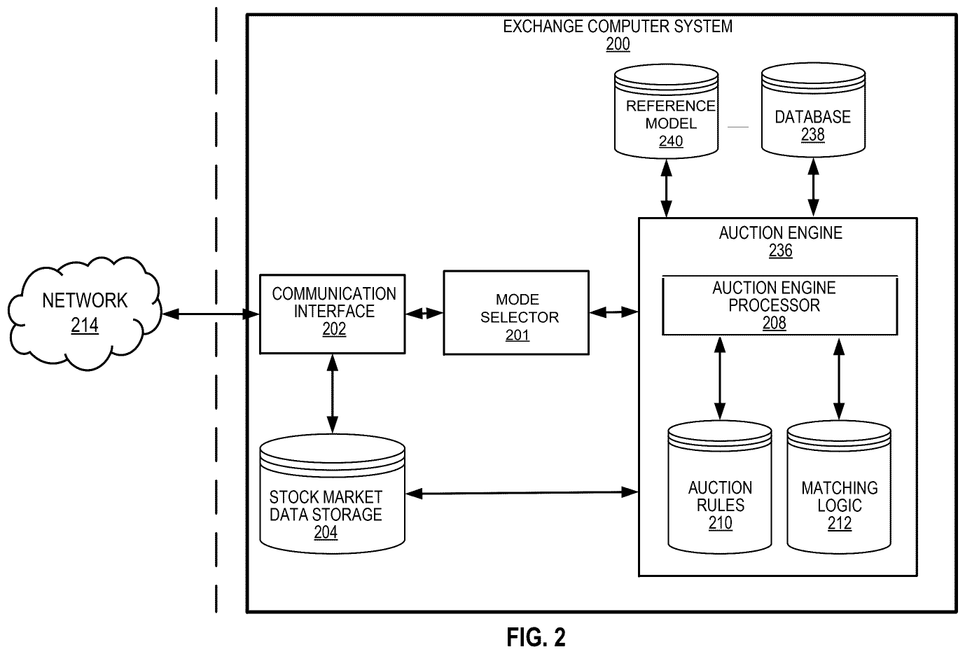

In some implementations, the auction engine 136 is implemented using a combination of software and hardware. The auction engine 136 can, for example, be implemented as one or more hardware processors configured to execute one or more algorithms, as described in further detail below. An example configuration of an exchange computer system featuring the auction engine 136 is more fully described below in FIG. 2.

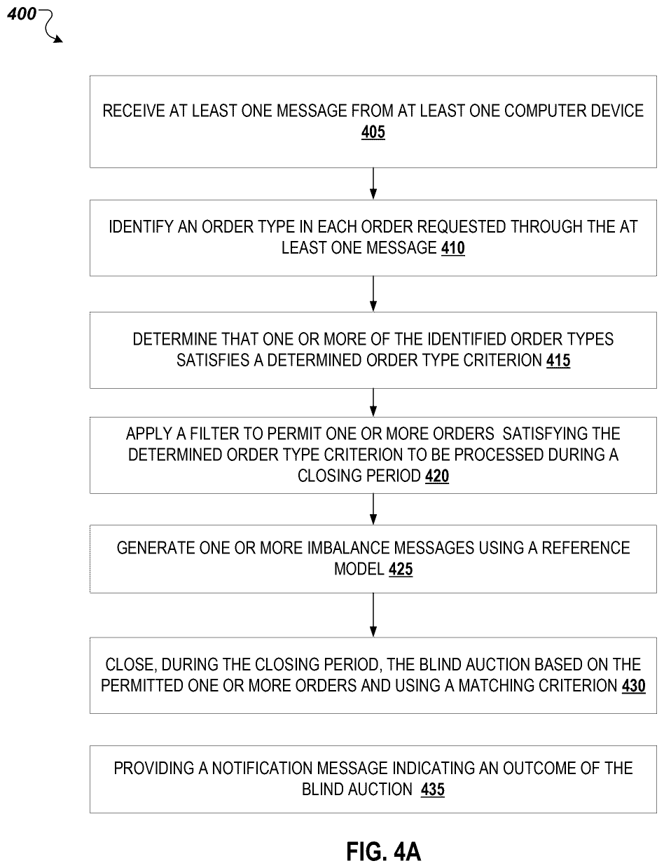

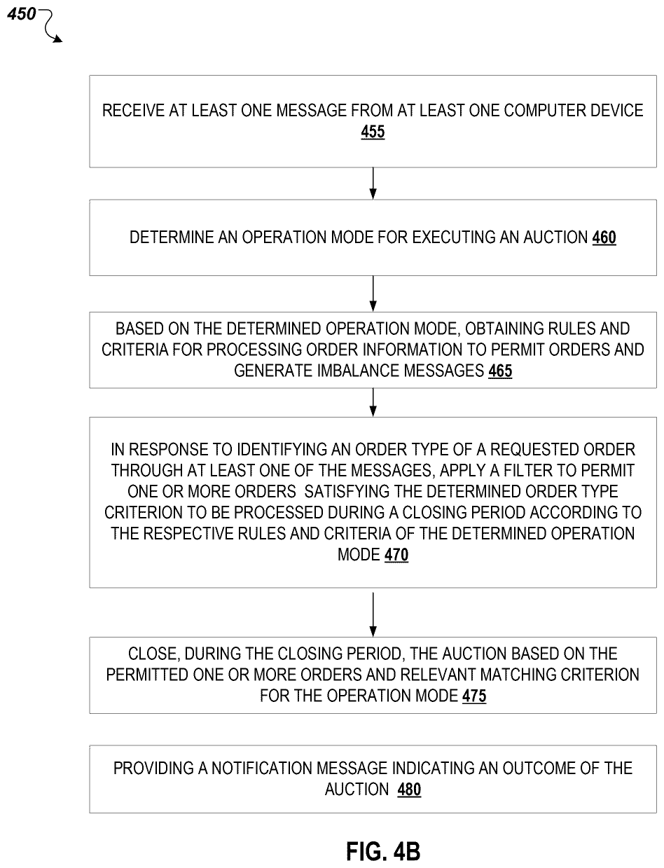

The auction engine 136 may generate imbalance messages based on information received from one or more networked user devices. The auction engine 136 may generate the imbalance messages and implement filters during the auction execution by following processes further described, for example, with respect to FIGS. 3A, 3B, 4A, and 4B. After performing a close of an auction, the auction engine 136 may notify other exchanges (e.g., exchanges 112) and one or more user devices (e.g., user devices 116, 118, 120) of an outcome of the auction using network 114. As noted above, execution of an auction as a blind auction and running it through the auction engine of the exchange computer system 110 can significantly reduce the bandwidth and computing resources required by both the exchange computer system 110 and networked computer systems (e.g., user devices 116, 118, and 120) in each of several ways.

For example, as a component of exchange computer system 110, the auction engine 136 is well suited to the role of a centralized and authoritative creator of imbalance messages according to a predefined format relevant for executing a blind auction, at least insofar as it is able to efficiently generate the imbalance messages using data to which exchange computer system 110 already has access. In contrast, and absent the service provided by the auction engine 136, the exchange computer systems 110 would need to devote significant bandwidth to publish orders during imbalance phase and process fluctuating volumes of orders over time (e.g., with expected peak periods at imbalance periods), which can require provisioning more computational resources to maintain a service level of the auction execution that matches varying needs for processing order information.

As another example, auction engine 136 vastly reduces the number of messages that need to be sent, received, and processed in connection with strategies leveraging the information captured and represented during a blind auction in accordance with the techniques disclosed in the present application. More specifically, the auction engine 136 enables connected devices to practically leverage imbalance information in a manner that reduces the number of messages involved in implementing and fulfilling complex strategies that would otherwise require relatively higher number of order requests, with relatedly higher computational expenditure for the auction engine as compared to cases when a blind auction is executed.

Additionally, the practical application of executing auctions in multiple modes, including executing a blind auction, enables fulfillment of complex strategies with significantly less network traffic than would otherwise be necessary, at least by virtue of the reduced numbers of messages involved. In at least these ways, the generation of imbalance messages, and the processing of orders associated with blind auction execution, significantly improves the computational efficiency with which complex strategies can be implemented and fulfilled.

The exchange computer system 110 may be configured to receive data from one or more user devices (e.g., user devices 116, 118, and 120) by the network 114 connected to the exchange computer system 110. The received data describes a request to enter an order for an option in the electronic order book 124. The exchange computer system 110 facilitates the transaction by determining a second order in the electronic order book 124 matches the order described in the received data at close of an auction. The exchange computer system 110 may utilize the ORS 132 to route the order from the received data and the OMS 134 to match the second order in the electronic order book 124 to the order.

The exchange computer system 110 may also be configured to simultaneously receive (e.g., by the network 114 and ORS 132 of the exchange computer system 110) from one or more user devices, multiple orders for execution at an auction. The exchange computer system 110 receives a third order while the second order in the electronic order book 124 matches the order from the received data.

The electronic order book 124 may include a closing call book and the determined transaction price of the order from the received data can be based on a closing price calculated at a closing period. In some implementations, the closing call book can be maintained as a separate book not part of the electronic order book 124, where orders for the auction can be tracked and maintained separately.

In some implementations, the electronic order book 124 may include a mark-to-model order book and the determined transaction price of the order from the received data is based on a daily settlement price determined by one or more financial models. For example, the daily settlement price may be provided by a financial model when a market for the underlying asset is not available, e.g., for complex financial instruments. In some implementations, the daily settlement price may be determined from a non-total return forward curve with a known expected dividend return.

In some implementations, the exchange computer system 110 is a distributed computer system that includes an order entry port (e.g., by network 114), an order routing system (e.g., ORS 132), an order matching system (e.g., OMS 134), and the auction engine (e.g., auction engine 136). The distributed computer system may operate multiple hardware and software processes in parallel configurations. The order entry port receives the order from the data sent to the exchange computer system by a user device and the order routing system is configured to route the order to a destination associated with the order. As an example, the destination may include other exchanges 112, based on matching rules stored on database 138 and the configuration of the order matching system to match the order to the destination in the other exchanges 112.

Storage 140 and database 138 store and handle data in a manner that satisfies the privacy and security requirements of the exchange computer system 110 and its users, and may store one or more of telemetric data, user profiles, user history, and rules and algorithms for matching quotes, bids, and orders.

Upon completion of a trade, the fill information is passed through the OMS 134 and the ORS 132 to one or more user devices 116, 118, 120, and 124, and to a trading engine. The trading engine can match the buy side and sell side of a trade, and forwards the matched trade to a third party organization that verifies the proper clearance of the trade, such as the Options Clearing Corporation (OCC) where the securities may be options, or Depository Trust Company (DTC) where the securities may be equities. The OMS 134 also formats the quote and sale update information and sends that information through an internal distribution system that refreshes display screens on the floor, in addition to submitting the information to a quote and trade dissemination service such as, in the case of options, the Options Price Reporting Authority (OPRA). In the case of Equities, the information would be submitted to the Securities Information Processor (SIP).

FIG. 2 is a diagram of an example exchange computer system 200 with an auction engine 236 configured for executing auctions such as a blind auction. The exchange computer system 200 may be implemented by software, hardware, or some combination as described herein. As an example, the exchange computer system 200 may be implemented as a server, a computer, or other device or processing component using proprietary software designed and implemented to achieve the functionality described herein. The exchange computer system 200 may be distributed or subdivided between a plurality of entities e.g., multiple computing devices. In some implementations, one or more parts of the exchange computer system 200 may be the same as similar systems described in the exchange computer system 110 in FIG. 1.

The exchange computer system 200 may include a communication interface 202, coupled with a stock market data storage 204. The communication interface 202 may be communicatively linked to the auction engine 236, which includes an auction engine processor 208, auction rules 210, and matching logic 212. The communication interface 202 can be connected to the auction engine 236 through a mode selector 201, where requests received at the communication interface associated with order execution at the auction engine 236 can be processed at the model selector 201 to determine the mode of operation for the auction to be executed by the auction engine 236. In accordance with the present implementations, the auction engine 236 can support multiple operation modes for execution of an auction including a blind auction and a fully transparent auction as described throughout the present disclosure. The auction engine 236 may also be communicatively linked to an ordering matching system, an order routing system, a rules database, and storage of the exchange computer system 200, e.g., as described in relation to FIG. 1 and the auction engine 136.

The communication links in the exchange computer system 200 may be established by a system bus, network, or one or more other connection mechanisms. As an example, the connection mechanisms may include a wired connection, a wireless connection, or a combination thereof. For example, the connection may be a physical connection, such as a wired Ethernet connection. In another example, the connection may be a wireless connection, such as a cellular telephone network, an 802.11, 802.16, 802.20 controls or components, a WiMax network, or any other type of network. Further, network 214 may be a public network, such as the Internet, a private network, such as an intranet, or combinations thereof, and may utilize a variety of networking protocols now available or later developed including, but not limited to TCP/IP based networking protocols.

The auction engine processor 208 may include one or more processors, such as general-purpose processors (e.g., a microprocessor), special-purpose processors (e.g., an application-specific integrated circuit (ASIC) or digital-signal processor (DSP), programmable-logic devices (e.g., a field programmable gate array (FPGA)), or any other processor components now known or later developed. The auction engine processor 208 may include a timing circuit that can represent an internal clock configured to generate data indicating a current time and date, including day, month, and year. As explained below, the clock data may be used to determine whether an order is eligible to be executed during an auction (e.g., a blind auction as described in relation to FIG. 4A) on the exchange computer system 110, 200. The auction engine processor 208 may carry out one or more instructions using one or more arithmetic, logical, and/or input/output operations. Though auction engine processor 208 is illustrated as a single component, the auction engine processor 208 may be integrated in whole or in part with other components of the exchange computer system 200. The auction engine processor 208 can include an internal timer, in some implementations. In another implementation, the timer can be implemented in other hardware or software components in the exchange computer system 110, 200.

The stock market data storage 204, auction rules 210, and the matching logic 212 may be a main memory, a static memory, or a dynamic memory. Stock market data storage 204 and storage for auction rules 210 and matching logic 212 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media, organic storage components, and the like. As an example, the market data storage 204, the auction rules 210, and the matching logic 212 may include a cache or random access memory for the auction engine processor 208. Stock market data storage 204 and storage for auction rules and matching logic may be separate from the auction engine processor 208, such as a cache memory of a processor, the system memory, or other memory. The stock market data storage 204, the auction rules 210, and the matching logic 212 may be an external storage device or database for storing data. Examples may include a hard drive, compact disc (“CD”), digital video disc (“DVD”), memory card, memory stick, universal serial bus (“USB”) memory device, or any other device operative to store data.

As further shown, the auction engine 236 may implement auction logic to carry out various functions, such as the functionality of the methods and systems described herein. In some implementations, the functions, acts or tasks may be independent of the particular type of instructions sets, storage media, processor or processing strategy and may be performed by software, hardware, integrated circuits, firm-ware, micro-code and the like, operating alone or in combination. Processing strategies may include multiprocessing, multitasking, parallel processing and the like.

In the exchange computer system 200, the communication interface 202 may include one or more structures, and associated equipment, for receiving data from one or more sources and distributing data to a group of one or more destinations. In some implementations, the communication interface 202 may include one or more additional communication interfaces and can operate in different configurations (e.g., distributed system, parallel). The communication interface 202 may be configured to receive input datasets from one or more entities (e.g., user devices or other exchanges) and store all or part of the input datasets in stock market data storage 204. The communication interface 202 may also be configured to communicate all or part of the auction engine 236 once the input datasets are stored or otherwise processed. The communication interface 202 may include a transceiver having one or more input/output ports connected to the network 214 to securely transmit data for one or more orders requested for execution at the auction engine 236 to user computing devices.

As an example, the data are stored in the stock market data storage 204 may be partitioned (e.g., horizontal, vertical, functional) into designated memory locations (e.g., virtual addresses) based on qualities of the input datasets, e.g., a type of order such as a market on close order, a limit on close order, a last limit on close order, etc. In some implementations, input datasets with data related to component stock options may be stored in market data storage 204 and include a linking identifier (e.g., address, memory mapping) to identify a corresponding stock for each of the component stock options. In some implementations, the market data storage 204 may be configured to receive an indicator describing the operating status (e.g., receiving, clearing, storing) of input datasets of the communication interface 202. The input datasets from the communication interface 202 may include financial market data (e.g., market intelligence) corresponding to the underlying asset traded during an auction executed at the auction engine 236. For example, financial market data may include volatilities, interest rates, dividends, returns (e.g., historical, expected), market capitalization, sector, prices, liquidity, and other metrics related to the underlying asset. Financial market data may also include measures, estimates, and other related data for options (e.g., calls, puts), futures, and other derivatives associated with a closing auction. The input datasets may also include corresponding log files to describe and store the financial market data e.g., a log file describing the auction orders. The log files may include metadata to tag or characterize data, e.g., corresponding time periods for which the data was recorded. For example, the log files may include a tag to be used for sorting or filtering the data of the log files.

Upon receiving of messages associated with requested orders from the communication interface 202, the auction engine 236 may perform further processes as described in relation to FIGS. 3A, 3B, 4A, and 4B. The auction engine 236 may perform operations using the auction engine processor 208, with instructions stored in the matching logic 212 for matching orders at auction close, and data stored in auction rules 210. The data stored in auction rules 210 may include data that can be used to filter orders to be permitted for processing at auction close through the auction engine 236. The auction engine 236 can utilize metadata, including log files, to process (e.g., filtering, sorting) receives messages associated with requested orders according to auction rules 210. In some implementations, the auction engine processor 208 can process requested messages, for example, according to a selected mode of operation for executing an auction, as described in the methods 400 and 450 of FIGS. 4A and 4B.

As noted above, the exchange computer system 110 can securely transmit information related to outcomes of auctions to connected user computing devices (e.g., user devices 116, 118, 120) that are themselves configured to display the information. For example, the information may be displayed within a graphical user interface of an application that facilitates continuous real-time generation and trading through the exchange computer system 200.

FIG. 3A is s an illustration of periods for executing an auction in a blind mode 300 where different rules for messaging and permission rules for order types are defined so that the action can be executed through the auction engine of FIGS. 1-2.

In some implementations, an exchange computer system as described in relation to FIGS. 1 and 2 can provide an auction engine that can be configured to execute a closing auction in a blind auction mode. The closing auction can be provided as an electronic auction process where any one of the participants is not provided with advantageous information and thus supports a fair and efficient closing process.

In some instances, the blind auction can be defined to include multiple periods defined according to the schema 300, and including a pre-imbalance period 305, an imbalance period 310, a closing cutoff period 315, a closing period 320, and a price movement extension period 325. During the multiple periods, requests for orders can be received from a computing network coupled to computer devices of participants. A filter can be applied for orders received at each period, where the filter can be specific to the period of the blind auction, the type of orders, and the type of action with regard to the orders (e.g., entering a new order, cancelling an order, modifying a previous order).

### Participating in a Blind Closing Auction

At a first period being the pre-imbalance period 305, orders may be entered, amended, or cancelled and those orders can be tracked into a closing call book. For example, the orders can be MOC and LOC orders. In some implementations, the closing call book can be maintained at a storage local or connected to the auction engine. For example, the pre-imbalance period 306 can be defined to start at a predefined time of the day, e.g., 7:00 AM, and a set of order types may be allowed to be requested over time until the second period, the imbalance period 310 starts. In some instances, when a request for an order is send from a market participant through a computing device of the market participant, a routing system of the exchange computer system can receive the request, track the time of the receipt of the request and provide the message to an auction engine to process the message according to the rules of the auction. The order can be processed according to a criterion for order types to be permitted at a respective period of the blind auction.

During the imbalance period 310, imbalance messages can be generated by the auction engine so that they can be provided to be published through the exchange computer system over a computer network to connected computing devices, e.g., computing devices of users requesting orders for the auction, or on a public market data feed. In some instances, the imbalance messages can be published according to a timing schema, e.g., at regular intervals, at predefined time points, or other defined timing schema, until a closing period 320 is reached. For example, a closing call can be received at a predefined time associated with the closing period 320, e.g., 4:00 PM.

In some implementations, the blind auction can be executed with reference to timing of receipt of messages associated with requested orders to be executed at the blind auction. Received messages with orders can be tracked based on time of receipt and processed according to blind auction criteria associated with that time of the day. In such way, orders can be filtered so that one or more orders can be permitted into the closing period or matched at close by using the tracked time for each order and the defined periods of the blind auction during a period of time of the day.

In some instances, while some orders can be received during the imbalance period and the closing cutoff period 315 according to implemented filters and respective order type criteria, imbalance messages with updates of imbalance information can be distributed and the imbalance information can be used by auction participants to determine whether to enter further orders into the auction. The imbalance messages can be transmitted at regular intervals or according to another time schedule where the imbalance information can include an indicative price at which the close may be executed and a total of quantity of shared that would be matched at the relevant time.

During the imbalance period 310, received orders for participation in the auction or modifying previous orders for participation in the auction can be filtered by applying a filter implementing rules for permitting or refusing orders according to an order type criterion defined for the imbalance period. For example, new MOC and LOC orders may be entered and cannot be cancelled. As such, the auction engine can execute filters that can limit cancelation of previously entered orders. MOC orders cannot be modified while the price of LOC orders may be modified, but only if the modification in the price will result in a more aggressive price.

During the closing cutoff period 315, newly received orders or requests associated with previous orders can be filtered according to auction rules defined for the closing cutoff period 315. For example, a filter can be applied during the closing cutoff period 315 that a new Late Limit on Close (“LLOC”) order may be permitted to be entered but cannot be amended or canceled. The filter implemented for the closing cutoff period 315 can be applied to refuse requests for new MOC and LOC orders to be entered, while also refusing that previously entered MOC and LOC be modified or cancelled. In practice, during a closing cutoff period 315, permitted orders for the auction that were requested at previous times may not be modified and stay included for processing at the closing period 320, while a late limit on close order type is a type of orders that is permitted to be requested during the closing cutoff period 315 so that such an order can be included in the closing period 320 of the blind auction.

The blind auction can be executed during a first session established at the exchange computer system, where the first session can be a continuous trading session that is implemented in parallel to the blind auction. At the end of the first session, all orders that have been permitted to be included in the closing period 320 based on applying the filtering at each period of the auction as described above, will be included in the closing period 320.

Orders that are ineligible to participate in the closing period 320 (e.g., filtered during one of the periods of the blind auction) will be eligible for trading in the price movement extension period 325. All permitted orders into the closing period 320 (e.g., orders of different types including MOC, LOC, LLOC) that were entered prior to the start of the closing period 320 can be maintained in a closing call book (e.g., as part of an order book 124 of FIG. 1) that can be a separate electronic book, which will not be published over a public market data feed. The exchange computer system also includes another electronic book of orders and quotes with which incoming orders that are not processes and permitted into the closing period based on the same rules as the rules of the blind auction.

### Calculated Closing Price (“CCP”)

A calculated closing price (“CCP”) can be determined at the closing period 320 of the blind auction by combining orders residing in the closing call book and in an electronic book of the exchange computer system that are eligible to participate in the closing period. The CCP can be determined based on executing implemented logic at the auction engine. The CCP can be determined as a single price that is determined in a way to maximize the traded volume at the closing period. In the event that more than one CCP can be associated with equal traded volume, the multiple CCPs can be considered as candidate closing prices where the multiple CCPs can be evaluated according to price evaluation rules to identify a single closing price. For example, the candidate CCPs can be evaluated according to the following example of rules:
The price that will leave the smallest imbalance; and.
If the imbalance is equal for more than one price, the price that is closest to the instrument's last traded price through the exchange computer system can be selected; and.
If two prices are of equal distance to the last traded price through the exchange computer system, the price that is to be selected would be the higher of the two prices.

### Matching of Orders

The matching allocation of orders at the closing period 320 can be performed according to a matching priority at the closing price. At the start of the execution of the matching, the side opposite of the indicated imbalance direction will aggress the book. In the absence of an imbalance, the buy side will aggress the sell side.

In some implementations, the blind auction can be closed using a matching criterion that is to be used for matching orders eligible to trade in the closing period. The matching criterion can define the following sequence of matching or orders:
1. MOC orders,
2. Better priced Limit, LOC and LLOC orders,
3. Limit, LOC and LLOC orders priced at the CCP.

In some implementations, if there are multiple orders within each order type above on the aggressing side, the orders will be executed according to time priority. If there are multiple orders within each order type above on the passive side, the orders will be executed in a priority matching order including a sequence of a broker, trader, and time.

Board Lot portion of a mixed lot order is eligible to participate in the Closing Call. Odd lot portion of a mixed lot order is not eligible to participate in the Closing Call, and will not be executed immediately following the Closing Call. Mixed lot orders that are not fully executed in the Closing Call can be eligible for trading in the Extended Trading Session. Upon execution of the Closing Call, any remaining odd lot orders will expire.

### Delayed Closing

At the time of the closing period 320, the CCP can be validated against established price band parameters set by the exchange computer system. In the event the CCP exceeds the price band parameters as set by the exchange com, the auction engine can be configured to delay the closing based on the permitted orders into the closing period and generate and publish a message identifying the security subject to the delay. At the time of the closing period 320, where a delayed closing is necessary, an imbalance message can be generated and publish to indicate the delay.

During delayed closing, a price movement extension period 325 can be defined (e.g., for a fixed period of time such as from 4:00 to 4:10 pm). During the price movement extension period 325, new MOC and LLOC orders cannot be entered, and previously entered MOC, LOC, and LLOC orders cannot be amended or cancelled. As such, the auction engine can apply filters to permit orders that meet the order type criterion for that period. In some instances, new LOC orders may be permitted to be entered if they are on the opposite side of the imbalance at a limit price that is within the closing price threshold range. At the end of the price movement extension period 325, the CCP is recalculated and validated against a closing price threshold (“CPT”) parameter. In the event that the CCP is outside of a defined CPT range, the close of the blind auction can be complete at the price at which most volume will trade, leaving the smallest imbalance within the CPT range. Any unfilled MOC, LOC, LLOC and RHO orders will be cancelled immediately following the Closing Call.

FIG. 3B is an illustration of executing an auction in multiple modes including a schema for executing a fully transparent auction and a blind auction, where the auctions can be through the auction engine of FIGS. 1-2. In some implementations, a closing auction can be executed at an exchange computer system as described in relation to FIGS. 1-2, where the auction can be performed in one of multiple operation modes. As described in relation to FIG. 2, when a request is received at an exchange computer system, a multimode selection (such as the mode selector 201) can be engaged with the received message for executing an order, where an operation mode can be selected from a set of available modes maintained by an auction engine (such as the auction engine 236 of FIG. 2). In some instances, the mode of operation can be selected to a blind mode 300, where a blind auction can be executed. In some instances, the blind auction can be executed as described in relation to the method of FIG. 4A, and for example, according to the example schema and rules as described in relation to FIG. 3A. In some instances, the mode of operation can be selected to a fully transparent mode according to a defined schema 350 of periods of the auction and respective auction rules to be applied during the auction. Each of the period of the fully transparent mode can be associated with rules for allowed order types that can be used to filter orders to be permitted into the close of the auction in a similar way as to the application of filters during a blind auction. During the continuous trading phase, MOC and LOC orders can be allowed, as well as modifications and cancelations of such type of orders can be allowed. During the imbalance phase, regular limit orders, MOC, and LOC can be allowed, while odd lots and dark orders can be rejected. MOC and LOC can be allowed to be modified and cancelled. The closing period can be executed at a randomly determined time point within a predefined time range, e.g., between 4:05 PM and 4:05:30 PM. The price movement extension period can be configured to be executed after the closing period where filtering of orders can be implemented based on the same filters as those applied during the imbalance phase.

The schema 350 of the fully transparent mode includes four periods: continuous trading, imbalance phase, closing period, and a price movement extension period. In contrast with the blind auction definition, the fully transparent mode does not include a closing cutoff period, and the closing period can be executed at a randomized time. While the auction is executed as a fully transparent auction, orders received from computing devices as described in relation to the blind auction are published so that visibility is provided. In contrast, during a blind auction, such orders are not published and only imbalance messages are published. During the imbalance phase of the fully transparent mode, imbalance messages can be published in addition to publishing orders. The imbalance messages can be generated according to an imbalance message schema including a set of fields such as.
Symbol—similar to the symbol field of the imbalance message during a blind auction as described above;
Indicative price—similar to the indicative price field of the imbalance message during the blind auction as described above;
Imbalance side—opening or closing shares that would remain unexecuted at closing price; and
Imbalance volume—a number of opening or closing shares that would remain unexecuted at closing price.

During a fully transparent auction, the imbalance messages are published if there is a change to any one of the imbalance message fields. The publishing of orders in addition to imbalance messages provides visibility of the orders during the imbalance period that can trigger higher fluctuation in the size of orders entered into the auction, price changes, and increase load on the auction engine to process the orders and generate and publish the information through the exchange computer system.

FIG. 4A is a flowchart of an example process for implementing a blind auction on the exchange computer system of FIGS. 1-2. The method can begin at operation 405 where a computer system (e.g., the exchange computer system of FIGS. 1-2), an auction engine (e.g., the auction engine of FIG. 1 or 2), or a routing system (e.g., the order routing system of FIG. 1), can receive, from a computer network coupled to at least one computer devices, at least one message.

In some implementations, the at least one computer device can be a remote device of at least one user that is configured to display data related to requested and executed orders including orders requested for executing a closing auction. The at least one computer device display the data within a graphical user interface of an application that facilitates continuous real-time trading. The at least one computer device can be used by a user to communicate with an exchange computer system and exchange financial instructions. Utilizing the graphical user interface, the at least one computer device can be configured to receive user inputs that defines data related to requested order(s) to be executed at a closing auction through the exchange computer system (e.g., a blind auction, a transparent auction, other).

The method 400 can be implemented utilizing an auction engine. In one example, the auction engine can be the auction engine 136 as described in relation to FIG. 1, or the auction engine 236 as described in relation to FIG. 2. The auction engine can be part of an exchange computer system as shown in FIGS. 1 and 2.

In some instances, the received at least one message at 405 can be indicative of one or more orders requested from user computer devices over a network and received directly at the auction engine or through a routing system, such as the order routing system 132 of FIG. 1.

In some instances, and with reference to FIGS. 1 and 2, a network connection can be established over the network 114, 214 that enables the at least one computer device (e.g., a user computing device such as a mobile computing device (e.g., a mobile phone, portable device, etc.) or PC) to receive and transmit data to and from the exchange computer system. In some implementations, data may be transmitted as messages to the exchange computer system indicating details of the computing device, and/or data indicating one or more requested orders, or combinations thereof. Data can include the name of an asset traded, volume, price, information indicating a type of order (e.g., market on close order, limit on close order, etc.), information indicating whether the request is related to a previously placed order. In some instances, the data can be provided in different fields of the messages so that details of the requested orders can be identified through processing one or more of the fields.

At 410, the computer system identifies an order type in each order requested through the at least one message. The identification of the order type can be performed by extrapolating one or more bits from each of the at least one message corresponding to an order type field in each of the at least one message. The one or more bits can be compared to data obtained from a look-up table, for example, stored in one or more databases associated with the computing system. An order type for each requested order through the at least one message can be identified based on the comparing of the one or more bits to the data in the look-up table.

In some implementations, messages can be received over time, and for each message an order type associated with the requested order can be identified and used later on to determine whether to permit the order into the closing period based on blind auction rules.

At 415, the system can determine that one or more of the identified order types satisfies a determined order type criterion. In some implementations, the order type criterion can be determined with reference to a period of the blind auction, for example, as described in relation to FIG. 3A. For example, some order types are permitted to be entered during a first period of a blind auction, while other order types are permitted to be entered at a third period of the blind auction (e.g., closing cutoff period 315 of FIG. 3A).

At 420, the system can apply a filter to permit one or more orders that have the one or more of the identified order types satisfying the determined order type criterion to be processed during a closing period. In some implementations, at each blind auction period, filters can be configured to apply respective criterion to determine which order types can be permitted and for what type of requests, e.g., entering an order, modifying an order, cancelation of an order. In some instances, at a given blind auction period, a set of actions for a type of an order can be defined to be permitted at a respective filter that is applied to process incoming messages associated with requested orders to be executed at the blind auction.

At 425, one or more imbalance messages can be generated using a reference model. The one or more imbalance messages can include imbalance information associated with the blind auction. For example, the imbalance messages can be such as the imbalance messages generated and published as described in relation to FIG. 3A.

In some implementations, the generation of the imbalance messages can include generation of a plurality of fields for the messages including:
a symbol field indicative of a symbol associated with a security;
a reference price field associated with a price level at or within a national best bid and offer;
a reference buy shares field associated with a total number of shares for a buy side of an order priced at a value equal to or greater than a reference price associated with the reference model;
a reference sell shares field associated with a total number of shares for a sell side of an order priced at a value equal to or less than the reference price;
an indicative price field associated with a first type of closing price; and
an auction only price field associated with a second type of closing price.

At 430, the system can close, during the closing period, the blind auction based on the permitted one or more orders and using a matching criterion. In some implementations the permitted orders can be processed during the closing period of the blind auction so that a closing auction price can be determined by determining a price that maximizes a volume of financial instruments to be traded. For example, the determination of the closing auction price can be performed as described in relation to FIG. 3A.

At 435, a notification message can be transmitted, e.g., through the routing system to the computer network indicating an outcome of the blind auction.

FIG. 4B is a flowchart of an example process for implementing a multimodal auction process on the exchange computer system of FIGS. 1-2. The method can begin at operation 455 where a computer system (e.g., the exchange computer system of FIGS. 1-2), an auction engine (e.g., the auction engine of FIG. 1 or 2), or a routing system (e.g., the order routing system of FIG. 1), can receive, from a computer network coupled to at least one computer devices, at least one message. The received at least one message can be associated with a requested order to be included in an executed auction through the exchange computer system.

At 460, a determination of an operation mode for executing the auction can be made. The operation mode can be selected from a set of available modes to establish a new auction, or the determination can be made to identify a running auction engine that maintains a respective mode of execution of an auction. For example, the determination can be that the auction mode is a blind auction or a fully transparent auction, as described in relation to FIGS. 3A and 3B.

At 465, based on determining the operation mode, rules and criteria for processing order information received through the at least one message are obtained. The rules and criteria can be relevant for the definition of a schema of periods for execution of the auction as well as rules for processing requests for orders at various times during the execution of the action (and at different period, e.g., as described in relation to FIGS. 3A and 3B). The obtained rules and criteria can be applied by a filter so that at least some of the orders are permitted and imbalance messages are generated when imbalance period is determined to start.

At 470, in response to identifying an order type of a requested order though at least one of the messages, the filter can be applied to permit one or more orders that satisfy the determined order type criterion to be processed during a closing period. For example, in response to determining that the order type is of a first type (e.g., LOC), it can be determined what is the order type criterion for the first type of orders, and the criterion can be applied to the requested order to determine whether the requested order is to be permitted (e.g., modifying a previously entered LOC at the given auction period). The different modes of operation of auction can include different rules and criteria for different types of orders at various periods of the auction (that may differ between modes), for example, as described in relation to FIGS. 3A and 3B.

At 475, the auction can be closed during the closing period based on the permitted one or more orders and relevant matching criterion for the operation mode. For example, the matching criterion for such as the matching criterion describes in relation to the closing period 320 of FIG. 3A.

At 480, a notification message indicating an outcome of the auction can be provided, for example, to the at least one computer devices from which messages were received or to a market data feed accessible according to a predefined access policy to connected computer devices or through a web interface.

A number of implementations have been described hereinabove. It should however be understood that various modifications may be made without departing from the spirit and scope of the disclosure. For example, various forms of the flows shown above may be used, with steps re-ordered, added, or removed. Accordingly, other implementations are within the scope of the disclosure and claims.

Embodiments and all of the functional operations and/or actions described in this specification may be implemented in digital electronic circuitry, or in computer software, firmware, or hardware, including the structures disclosed in this specification and their structural equivalents, or in combinations of one or more of them. Embodiments may be implemented as one or more computer program products, e.g., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor can receive instructions and data from a read only memory or a random access memory or both.

Elements of a computer may include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer may not have such devices. Moreover, a computer may be embedded in another device, e.g., a tablet computer, a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT), liquid crystal display (LCD), or light emitting diode (LED) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having the graphical user interface or a Web browser through which a user may interact with an implementation, or any combination of one or more such back end, middleware, or front end components. The components of the system may be interconnected by any form or medium of digital data communication, e.g., a communication network.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while actions are depicted in the drawings in a particular order, this should not be understood as requiring that such actions be performed in the particular order shown or in sequential order, or that all illustrated actions be performed, to achieve desirable results. Moreover, the separation of various system components in the embodiments described above should not be understood as requiring such separation in all embodiments, and it should be understood that the described program components and systems may generally be integrated together in a single software product or packaged into multiple software products.

Thus, particular embodiments have been described. Other embodiments are within the scope of the following claims. For example, the actions recited in the claims may be performed in a different order and still achieve desirable results.

What is claimed is:

1. A computer system comprising:
a routing system configured to receive at least one message from a computer network coupled to at least one computer device; and
at least one processor electronically connected to the routing system and configured to receive the at least one message from the routing system and to execute a blind auction during a first session, wherein, to execute the blind auction, the at least one processor is configured to:
identify an order type in each order requested through the at least one message by:
extrapolating one or more bits from each of the at least one message corresponding to an order type field in each of the at least one message;
comparing the one or more bits to data in a look-up table stored in one or more databases; and
identifying an order type for each requested order through the at least one message based on the comparing of the one or more bits to the data in the look-up table;
determine that one or more of the identified order types satisfies a determined order type criterion;
apply a filter to permit one or more orders that have the one or more of the identified order types satisfying the determined order type criterion to be processed during a closing period;
generate one or more imbalance messages using a reference model, the one or more imbalance messages comprising imbalance information associated with the blind auction;
close, during the closing period, the blind auction based on the permitted one or more orders and using a matching criterion; and
transmit a notification message through the routing system to the computer network indicating an outcome of the blind auction.

2. The computer system of claim 1, wherein the computer system operates in multiple operation modes, comprising:
a first operation mode in which:
the at least one processor is configured to execute a transparent auction and generate a first set of imbalance messages throughout the transparent auction; and
a second operation mode in which:
the at least one processor is configured to execute the blind auction and the one or more imbalance messages are generated during an imbalance period and the closing period of the blind auction.

3. The computer system of claim 1, wherein to generate the one or more imbalance messages using the reference model, the at least one processor is configured to:
generate, for each imbalance message, a plurality of fields including:
a symbol field indicative of a symbol associated with a security;
a reference price field associated with a price level at or within a national best bid and offer;
a reference buy shares field associated with a total number of shares for a buy side of an order priced at a value equal to or greater than a reference price associated with the reference model;
a reference sell shares field associated with a total number of shares for a sell side of an order priced at a value equal to or less than the reference price;
an indicative price field associated with a first type of closing price; and
an auction only price field associated with a second type of closing price.

4. The computer system of claim 3, wherein:
the first type of closing price is a price that maximizes a number of shares matched based on on-close orders and visible continuous orders; and
the second type of closing price is a price that maximizes a number of shares matched based only on on-close orders.

5. The computer system of claim 1, wherein:
the blind auction comprises at least a first period, a second period, a third period, a fourth period, and a fifth period;
during the first period:
the filter is configured to permit order types corresponding to a market on close order and a limit on close order; and
the at least one processor is configured to modify or cancel the market on close order or the limit on close order;
during the second period:
the filter is configured to reject a cancellation of a previously-recited market on close order or a previously-received limit on close order, and to permit a modification of a previously-recited limit on close order that modifies a pricing in the limit on close order to a price associated with a higher aggression level; and
the at least one processor is configured to generate and transmit the one or more imbalance messages periodically;
during the third period:
the filter is configured to reject a cancellation or a modification of a previously-recited market on close order, a previously-received limit on close order, and a previously-received late limit on close order, and to permit newly-received late limit on close order that has a price level that does not exceed a national best bid and offer level; and
the at least one processor is configured to generate and transmit the one or more imbalance messages periodically;
during the fourth period being the closing period:
the at least one processor is configured to receive orders that were permitted by the filter, to conduct and close the blind auction based on the orders that were permitted by the filter; and
during the fifth period:
the at least one processor is configured to implement a price movement extension for orders that were not permitted by the filter.

6. The computer system of claim 1, wherein the at least one processor is configured to determine a closing auction price during the closing period by determining a price that maximizes a volume of financial instruments to be traded.

7. The computer system of claim 1, comprising:
a timing circuit configured to provide a signal to the at least one processor indicating a time of day; and
the one or more databases configured to store the look-up table, a set of order type criteria including the determined order type criterion, and a set of matching criteria including the matching criterion, wherein the set of order type criteria and the matching criteria are respectively defined for each period of auction periods of the blind auction;
wherein the at least one processor is configured to apply the filter, at each period of the auction periods of the blind auction, to permit the one or more orders based on a time stamp associated with each requested order, a respective order type criterion for each period, and the time of day indicated by the signal received from the timing circuit.

8. The computer system of claim 1, wherein the first session is a continuous trading session that is implemented in parallel with the blind auction.

9. A computer-implemented method comprising:
receiving at least one message, each message including a requested order to be executed during a blind auction; and
executing the blind auction by:
applying a filter during a plurality of auction periods to permit one or more requested orders that have an order type satisfying an order type criterion defined for a current auction period, wherein the permitted one or more requested orders are to be processed during a closing period of the blind auction;
determining that an imbalance period has started;
in response to determining that the imbalance period has started, generating, according to a time schedule, one or more imbalance messages using a reference model, wherein the one or more imbalance messages comprise imbalance information associated with the blind auction; and
closing, during the closing period, the blind auction based on the permitted one or more orders and using a matching criterion; and
transmitting a notification message indicative of an outcome of the blind auction.

10. The method of claim 9, wherein applying the filter comprises applying the filter during the current auction period by:
determining that one or more of the identified order types satisfies a determined order type criterion for the current auction period; and
identifying an order from requested orders during the current auction period that matches the one or more determined order types, wherein the identified order is permitted for processing during the closing period of the blind auction.

11. The method of claim 9, wherein applying the filter comprises identifying an order type in each one of the requested orders comprising:
extrapolating one or more bits from each of the at least one message corresponding to an order type field in each of the at least one message;
comparing the one or more bits to data in a look-up table stored in one or more databases; and
identifying an order type for each requested order through the at least one message based on the comparing of the one or more bits to the data in the look-up table.

12. The method of claim 9, further comprising:
identifying an operation mode for executing an auction, wherein the operation mode is selected from a group consisting of a transparent mode and a blind mode;
in response to identifying the operation mode to be the transparent mode,
executing a transparent auction;
generating a first set of imbalance messages throughout the transparent auction; and
in response to identifying the operation mode to be the blind mode, executing the blind auction, wherein executing the blind auction comprises generating the one or more imbalance messages during an imbalance period and the closing period of the blind auction.

13. The method of claim 9, wherein providing to publish, according to the time schedule, the one or more imbalance messages using the reference model comprises:
generating the one or more imbalance messages using the reference model to include a plurality of fields including:
a symbol field indicative of a symbol associated with a security;
a reference price field associated with a price level at or within a national best bid and offer;
a reference buy shares field associated with a total number of shares for a buy side of an order priced at a value equal to or greater than a reference price associated with the reference model;
a reference sell shares field associated with a total number of shares for a sell side of an order priced at a value equal to or less than the reference price;
an indicative price field associated with a first type of closing price; and
an auction only price field associated with a second type of closing price.

14. The method of claim 13, wherein:
the first type of closing price is a price that maximizes a number of shares matched based on on-close orders and visible continuous orders; and
the second type of closing price is a price that maximizes a number of shares matched based only on on-close orders.

15. The method of claim 9, wherein the blind auction comprises at least a first period, a second period, a third period during which orders are filter, wherein applying the filter comprises:
applying a first filter during the first period comprising:
permitting orders of order types corresponding to a market on close order and a limit on close order; and
permitting to modify or cancel the market on close order or the limit on close order;
applying a second filter during the second period, the second period being an imbalance period, wherein applying the second filter comprises:
rejecting a cancellation of a previously-recited market on close order or a previously-received limit on close order; and
permitting a modification of a previously-recited limit on close order that modifies a pricing in the limit on close order to a price associated with a higher aggression level; and
applying a third filter during the third period comprising:
rejecting a cancellation or a modification of a previously-recited market on close order, a previously-received limit on close order, and a previously-received late limit on close order, and to permit newly-received late limit on close order that has a price level that does not exceed a national best bid and offer level,
wherein imbalance messages are periodically generated and provided to publish during the third period;

16. The method of claim 15, wherein the blind auction comprises a fourth period and a fifth period, wherein the method comprises:
receiving, during the fourth period, orders that were permitted during the applying of respective filters;
conducting and closing, during the fourth period, the blind auction based on the permitted orders; and
implementing, during the fifth period, a price movement extension for orders that were not permitted by any one of the applied filters.

17. One or more non-transitory computer-readable storage media encoded with instructions that, when executed by one or more computers, cause the one or more computers to perform operations comprising:
receiving at least one message from a routing system to execute an auction; and
in response to receiving the at least one message, executing a blind auction comprising:
identifying an order type in each order requested through the at least one message by:
extrapolating one or more bits from each of the at least one message corresponding to an order type field in each of the at least one message;
comparing the one or more bits to data in a look-up table stored in one or more databases; and
identifying an order type for each requested order through the at least one message based on the comparing of the one or more bits to the data in the look-up table;
determining that one or more of the identified order types satisfies a determined order type criterion;
applying a filter to permit one or more orders that have the one or more of the identified order types satisfying the determined order type criterion to be processed during a closing period;
generating one or more imbalance messages using a reference model, the one or more imbalance messages comprising imbalance information associated with the blind auction;
closing, during the closing period, the blind auction based on the permitted one or more orders and using a matching criterion; and
transmitting a notification message indicative an outcome of the blind auction.

18. The non-transitory computer-readable storage media of claim 17, wherein the instructions further cause the one or more computers to perform operations comprising:
determining an operation mode for executing the auction based on the received at least one message;
in response to determining the operation mode to be a blind auction, obtaining rules and criteria for processing order information to permit orders and generate imbalance messages during periods of the auction, wherein the one or more imbalance messages are generated during an imbalance period and the closing period of the blind auction.

19. The non-transitory computer-readable storage media of claim 18, wherein the instructions further cause the one or more computers to perform operations comprising:
in response to determining the operation mode to be a transparent auction, executing a transparent auction comprising:
obtaining rules and criteria for processing order information to permit orders and generate imbalance messages, wherein a first set of imbalance messages are generated throughout the transparent auction and transmitted to computing devices associated with the requested orders.

20. The non-transitory computer-readable storage media of claim 17, wherein generating the one or more imbalance messages using the reference model comprises generating, for each imbalance message, a plurality of fields including:
a symbol field indicative of a symbol associated with a security;
a reference price field associated with a price level at or within a national best bid and offer;
a reference buy shares field associated with a total number of shares for a buy side of an order priced at a value equal to or greater than a reference price associated with the reference model;
a reference sell shares field associated with a total number of shares for a sell side of an order priced at a value equal to or less than the reference price;
an indicative price field associated with a first type of closing price; and
an auction only price field associated with a second type of closing price.
